(19) United States
(12) Patent Application Publication
(10) Pub. No.: US 2015/0189455 A1
(43) Pub. Date: Jul. 2, 2015

(54) TRANSFORMATION OF MULTIPLE SOUND FIELDS TO GENERATE A TRANSFORMED REPRODUCED SOUND FIELD INCLUDING MODIFIED REPRODUCTIONS OF THE MULTIPLE SOUND FIELDS

(71) Applicant: Thomas Alan Donaldson, Nailsworth (GB)

(72) Inventor: Thomas Alan Donaldson, Nailsworth (GB)

(73) Assignee: AliphCom, San Francisco, CA (US)

(21) Appl. No.: 14/144,524

(22) Filed: Dec. 30, 2013

(51) Int. Cl. H04R 27/00

(52) U.S. Cl. CPC H04R 27/00; H04R 2227/00

(57) ABSTRACT

Embodiments relate generally to electronic hardware, computer software, wired and wireless network communications, and media devices or wearable/mobile computing devices configured to facilitate production and/or reproduction of spatial audio and/or sound fields with one or more audio spaces. More specifically, disclosed are systems, devices and methods to transform multiple sound fields that include audio to form a transformed reproduced sound field, for example, for a recipient of audio in a region. In one embodiment, a method includes receiving audio streams originating from audio sources positioned in sound fields relative to corresponding reference points. Further, the method includes transforming a spatial dimension of the sound fields to form a transformed reproduced sound field. In some examples, the method also includes causing transducers to project sound beams at a point in a region at which spatial audio is produced to present the transformed reproduce sound field to an audio space.

### CROSS-REFERENCE TO RELATED APPLICATIONS

This application is co-related to U.S. Nonprovisional patent application Ser. No. 13/______, filed Dec. 30, 2013 with Attorney Docket No. ALI-294, and entitled “Interactive Positioning of Perceived Audio Sources in Transformed Reproduced Sound Field that Include Modified Reproductions of Multiple Sound Fields,” which is herein incorporated by reference in its entirety and for all purposes.

### FIELD

Embodiments relate generally to electrical and electronic hardware, computer software, wired and wireless network communications, and media devices or wearable/mobile computing devices configured to facilitate production and/or reproduction of spatial audio and/or sound fields with one or more audio spaces. More specifically, disclosed are systems, devices and methods to transform multiple sound fields (e.g., reproduced sound fields or portions thereof) that include audio sources, such as one or more speaking persons or listeners, to form a transformed reproduced sound field, for example, for a recipient of audio in a region.

### BACKGROUND

Conventional telecommunication and network communication devices enable remote groups of users to communicate with each other regardless of the distances that separate the remote groups of users. For example, traditional teleconference equipment can provide the required means by which users can communicate with each other over various types of communications medium, including phone lines, IP networks, etc. Such teleconference equipment typically is usually adapted for use in the business or commercial context.

While are functional, there are various drawbacks to using conventional telecommunication and network communication devices. For example, a listener participating in a teleconference may not be able to readily discern the identity of a person who is speaking remotely, especially when there are a relatively large number of remote participants and a variety of similar-sounding voices that are unfamiliar to the recipient of audio. When listeners are not easily able to determine characteristics of an person speaking, such as the identity of the user, a relationship of the speaking person to the recipient, etc. Lack of such information generally is a disadvantage to the recipient of audio. A recipient, therefore, usually expends effort straining to comprehend what is being said while determining the identity of the person speaking (e.g., whether the person speaking is a foreign colleague or client, etc.).

In some cases, teleconference equipment includes video of distant users to assist a user to determine from where an audio source originates. However, the listener necessarily directs its attention visually to the source of audio rather than focusing on other sources of information, such as an interface of a personal computing device (e.g., a mobile phone or tablet), that might include subject matter important for the communication. Moreover, the use of video does not facilitate the immersion of a listener in spatial audio.

Thus, what is needed is a solution for transforming and/or presenting audio, such as spatial audio, to a listener in a region without the limitations of conventional techniques.

### BRIEF DESCRIPTION OF THE DRAWINGS

Various embodiments or examples (“examples”) of the invention are disclosed in the following detailed description and the accompanying drawings:

FIG. 1 illustrates an example of a media device configured to transform multiple sound fields for forming a transformed reproduced sound field at a region, according to some embodiments;

FIGS. 2A and 2B illustrate an example of transformed reproduced sound fields (and portions thereof) into which multiple transformed sound fields can be disposed, according to some examples;

FIGS. 2C and 2D illustrate examples of transformed reproduced sound fields (and portions thereof) into which multiple transformed sound fields can be disposed as a function of location, according to some embodiments;

FIGS. 3A and 3B illustrate examples of transformed reproduced sound fields (and portions thereof) into which multiple transformed sound fields can be disposed as a function of one or more parameters, according to some embodiments;

FIG. 4 illustrates an example of a media device configured to form a transformed reproduced sound field based on multiple audio streams associated with different media devices, according to some embodiments;

FIG. 5 depicts an example of a media device including a controller configured to determine position data and/or identification data regarding one or more audio sources, according to some embodiments;

FIG. 6 is a diagram depicting an example of a controller implementing a sound field spatial transformer, according to some embodiments;

FIG. 7 is a diagram depicting a functional block diagram illustrating the distribution of structures and/or functionality, according to some embodiments;

FIG. 8 is an example flow of performing transformation of sound fields, according to some embodiments; and

FIG. 9 illustrates an exemplary computing platform disposed in a media device in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

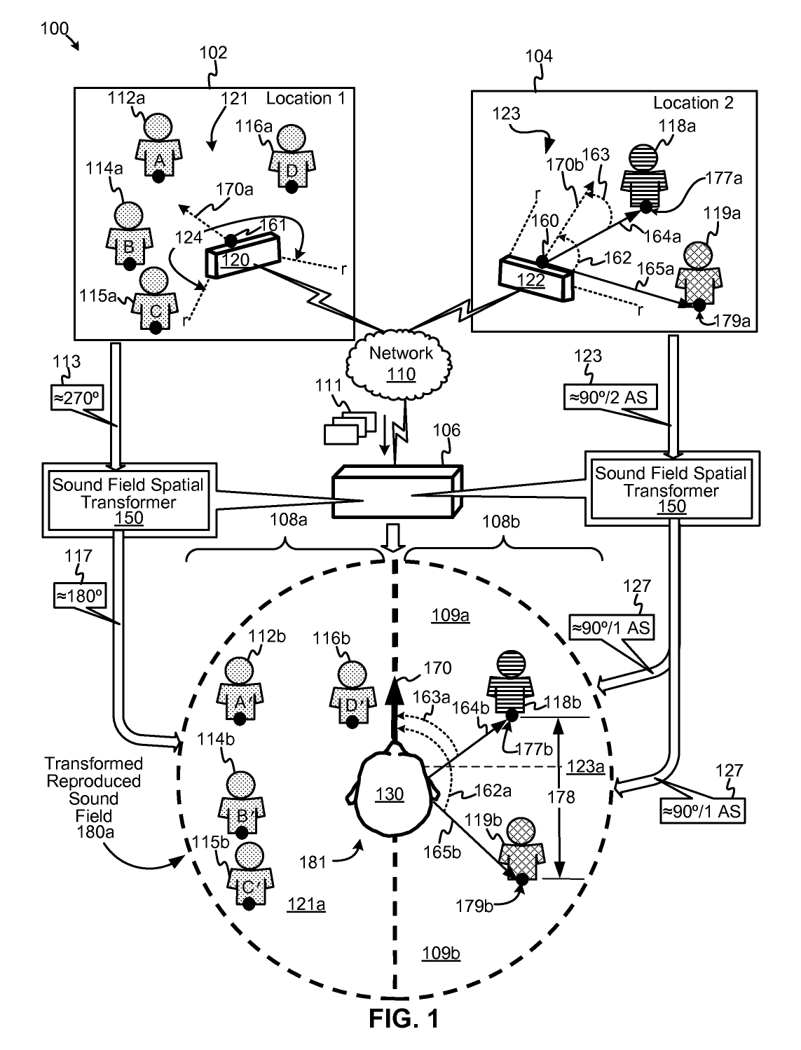

FIG. 1 illustrates an example of a media device configured to transform multiple sound fields for forming a transformed reproduced sound field at a region, according to some embodiments. Diagram 100 depicts a media device 106 configured to receive audio data 111 (e.g., via network 110) for presentation as audio to recipient or listener 130. Examples of audio data 111 include audio from one or more remote sources of audio, or audio in recorded form stored in, or extracted from, a readable medium. Diagram 100 also depicts at least two different locations from which different groups of audio sources generate audio that is transmitted to media device 106. A first location (“Location 1”) 102 includes a group of audio sources 112a, 114a, 115a, and 116a, whereas a second location (“Location 2”) 104 includes another group of audio sources 118a and 119a. Examples of such audio sources include one or more speaking persons or listeners, but can include other sources of sound. Media devices 120 and 122 are disposed at locations 102 and 104, respectively, to receive and/or produce sound waves in sound fields 121 and 123. In the example shown, sound field 121, which includes audio sources 112a to 116a, can be coextensive with a region (e.g., a sector) that spans an angle 124, which can be, for example, 270° relative to reference point 161 about media device 120 (e.g., a region including the front, right, and left sides, and portions of the rear side). Similarly, sound field 123 including audio sources 118a and 119a is coextensive with another region that spans an angle of, for example, 90° relative to a reference point (e.g., a remote reference point 160) at or adjacent to media device 122. According to some examples, arrangements of audio sources disposed in sound fields 121 and 123 may correlated to characteristics of sound fields 121 and 123, such as their corresponding sizes. According to some embodiments, media device 106 can generate acoustic signals as spatial audio that can form an impression or a perception at the ears of listener 130 that sounds are coming from audio sources (e.g., audio sources 112b to 119b) that are perceived to be disposed/positioned anywhere in a region (e.g., 2D or 3D space) that includes recipient 130, rather than just from the positions of two or more loudspeakers in the media device 106.

Further to FIG. 1, diagram 100 also depicts media device 106 including a sound field spatial transformer 150, which is configured to operate on audio data 111, which can represent one or more audio streams, received via network 110 from media devices 120 and 122. Note that while sound field spatial transformer 150 is depicted as two separate entities in diagram 100, sound field spatial transformer 150 can be implemented as a single structure and/or function, or as a combination of two or more similar or different structures and/or functions. According to some examples, sound field spatial transformer 150 can be configured to transform one or more dimensions (e.g., spatial dimensions) and/or attributes associated with sound fields 121 and 123 to form respective transformed sound fields that can be used to form a transformed sound field, such as transformed reproduced sound field 180a, in which recipient 130 can perceive remote groups of audio sources as originating from different directions in the region at which recipient 130 is located. Sound field spatial transformer 150 can transform a spatial dimension of sound field 121 such that sound field 121 (or a characteristic thereof) transforms from having an angular span 113 of 270° to an angular span 117 of 180°. Also, sound field spatial transformer 150 can transform a spatial dimension of sound field 123 so that sound field 123 (or a characteristic thereof) transforms from having an angular span 123 of 90°, including two audio sources (“AS”) (e.g., 90°/2 AS), to an angular span of 180°, which is depicted as two spans 127 of 90° (e.g., 90°/1 AS) in which each includes an audio source (“AS”). Sound fields 121 and/or 123 can be described, for example, as sectors having an area (e.g., including audio sources) bounded by two radii (“r”) that are displaced by an angle, according to some embodiments. Optionally, an arc, which is not shown in FIG. 1, may couple the two radii. According to various examples, sound field spatial transformer 150 can operate to combine, integrate, conjoin (e.g., by joining monolithic transformed sound fields), mix (e.g., interlace or interleave transformed sound fields and/or perceived audio sources 112b to 119b with each other), or otherwise implement multiple transformed sound fields to form a transformed reproduced sound field 180a.

Sound field spatial transformer 150 is configured to transform individual sound fields and combine them to form, for example, a unitary transformed reproduced sound field. As such, sound field spatial transformer 150 can be configured to generate a reproduced sound field that, for example, includes aural cues and other audio-related information to enable recipient 130 to perceive the positions of remote audio sources as they are arranged spatially in a remote sound field. For example, consider only sound field 121 is reproduced by sound field spatial transformer 150. In this case, audio sources 112a to 116a can be perceived by recipient 130 to be positioned as shown in location 102. Further, consider only sound field 123 is reproduced by sound field spatial transformer 150. In this case, audio sources 118a and 119a can be perceived by recipient 130 to be positioned as shown in location 104. In examples in which both sound fields 121 and 123 are reproduced for presentation to recipient 130, sound field spatial transformer 150 is configured to transform the reproduced versions of sound fields 121 and 123 so that recipient 130 can perceptibly detect perceived audio sources 112b to 116b are located separate from perceived audio sources 118b and 119b. As such, sound field spatial transformer 150 can transform the reproduced versions of sound fields 121 and 123 to form transformed sound fields. Note that recipient 130 may perceive an alteration or transformation in the directions from which audio originates from, for example, perceived audio sources 112b to 116b as compared to the directions from which audio originates from audio sources 112a to 116a in the original sound field 121. Therefore, sound field spatial transformer 150 can operate to reorient the perceived directions from which remote voices or sounds emanate.

Sound field spatial transformer 150 can transform one or more sound fields or reproduced sound fields to generate one or more transformed sound fields as a function of one or more parameters, according to various embodiments. By modifying, spatial dimensions in accordance with the parameters, sound field spatial transformer 150 can form a transformed spatial arrangement of perceived positions for audio sources 112b to 119b within transformed reproduced sound field 180a. These perceived positions can assist recipient 130 in determining an identity of a remote audio source (e.g., one of audio sources 112a to 119a) from which a voice or other audio originates, as well as other information.

An example of a parameter used to transform sound fields is a location parameter. According to some examples, data representing a location parameter identifies a location such as location 102 or location 104, relative to the location of a region in which recipient 130 is disposed. A location can be described as a specific geographic location defined by, for example, a particular longitude and latitude. From the location parameters, sound field spatial transformer 150 can dispose or otherwise orient locations transformed versions of sound fields 121 and 123 relative to the position of recipient 130. In the example shown in diagram 100, a first location parameter may indicate that location 102 is West (e.g., to the left) of recipient 130, whereas a second location parameter may indicate that location 104 is East (e.g., to the right) of recipient 130. Thus, sound field spatial transformer 150 can operate to dispose sound fields related to location 102 the left of recipient 130 and sound fields related to location 104 to the right of recipient 130. Another example of a parameter is a relationship parameter for which data represents a relationship between a remote audio source and recipient 130, such as an employee-employer relationship, a hierarchical relationship in an organization, a client relationship, a familial relationship, or the like, whereby higher-ranked employers and parents may be disposed directly in front of recipient 130 (or adjacent thereto) with lower-ranked employees and children being disposed to the left, right, or rear of recipient 130. Yet another example of a parameter is an importance-level parameter that identifies a remote audio source (or the subject matter of the conversation) as being relatively important compared to other remote audio sources. Note that recipient one three zero can, in some examples, a sign importance levels to one or more remote audio sources or remote sound fields. Should audio source 119b, for instance, represent a client or an individual who has critical information, audio source 119b may be disposed at a position, for example, directly in front of recipient 130. Therefore, recipient 130 can focus its attention on the position of the perceived audio source 119b to learn the critical information rather than losing focus or expending energy on deciphering which voice belongs to which remote audio source. Thus, recipient 130 need not expend effort or additional focus on determining the identity of the speaker rather than absorbing the information aurally. Note that other parameters are also possible, and sound field spatial transformer 150 is not limited to using the above-described parameters to transform sound fields.

In view of the foregoing, the functions and/or structures of media device 106 and/or sound field spatial transformer 150, as well as their components, can facilitate the reproduction of one or more audio sources that are perceived to have positions related to one or more parameters. As media device 106 can have two more transducers, spatial audio need not be produced by earphones or other near-ear speaker systems. Further, recipient 130 can engage in collaborative telephonic discussions with groups of people at different locations using sound field spatial transformer 150 to provide supplemental information they can aid the listener in determining various aspects of the communication, such as the quality of information being delivered, the importance of the information delivered, the identity of a speaking person based on perceived position, and other factors with which to determine whether the information is important to the recipient 130. Therefore, recipient 130 need not rely solely on identifying a remote speaker's voice or identity to determine the relevance of information that is conveyed verbally. Therefore, recipient 130 can use each of the perceived positions of audio spaces 112b to 119b (and the perceived directions from which audio originates) to more quickly and accurately form a response not only based on the information conveyed but, for example, the relationship to the recipient 130, a location of the remote person that is speaking, etc.

To illustrate an operation of sound field spatial transformer 150, consider an example in which recipient 130 is disposed in locations 102 or 104 as a substitute for respective media devices 120 or 122. In diagram 100, recipient 130 and its auditory systems (e.g., outer ear portions, including a pinna, etc.) face or are oriented toward a direction defined by reference line 170. Further to the example, consider that recipient 130, is disposed as a substitute for media device 120 in location 102 (not shown) so that the recipient faces a direction defined by a reference line 170a. In this orientation, the recipient perceives audio sources 112a, 114a, 115a, and 116a as producing audio in sound field 121 that spans an angle 124 of 270°. Alternatively, consider that recipient 130 is disposed as a substitute for media device 122 in location 104 (not shown) so that the recipient faces a direction defined by a reference line 170b. In this orientation, the recipient perceives audio sources 118a and 119a as producing audio in sound field 123 that spans an angle of 90°. According to some embodiments, sound field spatial transformer 150 is configured to transform spatial dimensions of sound fields 121 and 123 such that sound fields 121 and 123 are perceived by recipient 130 as transformed sound field 121a and transformed sound field 123a, respectively. In particular, sound field spatial transformer 150 of media device 106 can reproduce audio from sound field 121 (e.g., spanning 270°) so that the reproduced audio is perceived by recipient 130 as originating in a portion 108a of the transformed reproduced sound field 180a, whereas sound field spatial transformer 150 can reproduce audio from sound field 123 (e.g., spanning 90°) as being perceived by recipient 130 as originating in a portion 108b of the transformed reproduced sound field 180a. Thus, transformed reproduced sound field 180a can be formed by combining transformed sound field 121a and transformed sound field 123a. As shown, recipient 130 therefore perceives remote audio sources 112a, 114a, 115a, and 116a as being positioned at perceived audio sources 112b, 114b, 115b, and 116b in a reproduced sound field that spans 180° (e.g., on the left side of recipient 130 from the rear to the front, which is indicated by the direction of reference line 170), whereas recipient 130 perceives remote audio sources 118a and 119a as being positioned at perceived audio sources 118b and 119b in another reproduced sound field that spans 180° (e.g., on the right side of recipient 130).

To consider its operation further, sound field spatial transformer 150 can be configured to reproduce sound field 121 so that recipient 130 perceives sounds that originate from positions A, B, C, and D as originating from positions A′, B′, C′, and D′ relative to recipient 130. As shown, positions A, B, C, and D correspond respectively to remote audio sources 112a, 114a, 115a, and 116a relative to remote reference point 161 (and/or media device 120), and positions A′, B′, C′, and D′ correspond to perceived audio sources 112b, 114b, 115b, and 116b, respectively, relative to recipient 130. Further, sound field spatial transformer 150 can be configured to transform the reproduced sound field 121 to form portion 108a of transformed reproduced sound field 180a, and, as such, sound field spatial transformer 150 is configured to transform the spatial distances among positions A, B, C, and D (i.e., associated with a span of 270°) with each other to establish a perceived spatial arrangement at positions A′, B′, C′, and D′ (i.e., associated with a span of 180°) Note that distances between each of perceived audio sources 112b, 114b, 115b, and 116b may be scaled up or down, for example, to conform to increases or decreases in a size (e.g., area) of portion 108a.

As shown in diagram 100, sound field spatial transformer 150 can size an area (e.g., by changing the angle from 270° to 180° for a sector between two radii) so that the perceived distances between or among positions A′, B′, C′, and D′ are reduced. Similarly, sound field spatial transformer 150 is configured to reproduce sound field 123 so that recipient 130 perceives sounds that originate from positions 177a and 179a relative to remote reference point 160 (and/or media device 122), as originating from positions 177b and 179b relative to recipient 130. Further, sound field spatial transformer 150 is configured to transform the reproduced sound field 123 to form portion 108b of transformed reproduced sound field 180a, and, as such, sound field spatial transformer 150 is configured to transform the spatial distances between (i.e., associated with a span of 90° for sound field 123) with each other to establish a perceived arrangement at positions 177b and 179b (i.e., associated with a span of 180° associated with transformed sound field 123a). Note that the distances between each of perceived audio sources 118b and 119b can be scaled up or down, for example for portion 108b. Further to the example shown, sound field spatial transformer 150 can size a perceived area associated with transformed sound field 123a so that the perceived distances between positions 177b and 179b are increased to a distance 178. In some embodiments, sound field spatial transformer 150 can operate to transform the positions of the audio sources to any position within transformed sound fields 121a and 123a.

Sound field spatial transformer 150, according to some embodiments, can be configured to distribute positions (e.g., perceived positions) of the audio sources associated with sound field 121 or sound field 123 to be equidistant or substantially equidistant in transformed sound field 121a or transformed sound field 123a. Such distances may be described as arcuate distances, or distances following an arc. To illustrate, consider that audio sources 112b, 114b, 115b, and 116b can be disposed or spaced equally in transformed sound field 121a. For example, audio sources 112b, 114b, 115b, and 116b can be disposed at angles 36°, 72°, 180°, and 144°, respectively, counterclockwise from reference line 170 (not shown). Similarly, audio sources 118b and 119b can be disposed at angles 60° and 120°, respectively, clockwise from reference line 170. That is, angle 163a and angle 162a can be respectively 60° and 120°. In a particular example, sound field spatial transformer 150 is configured to dispose positions of each perceived audio sources in a transformed sound field such that each of the perceived audio sources occupy an equally-sized area or sector. As shown, reproduced audio sources 118b and 119b can be disposed in sectors 109a and 109b, respectively. Accordingly, audio sources in the transformed sound fields can be displaced at a maximal distances from each other to enable recipient 130 to more clearly delineate a direction and a position from which a sound (e.g., a voice) is transmitted.

According to some embodiments, sizes of portions 108a and 108b of respective sound fields 121a and 123a can be determined by the quantity of audio streams from media devices 120 and 122. For example, sound field spatial transformer 150 can be configured to determining a quantity of at least two audio streams, each originating in association with a reference point, such as reference points 161 and 162. Sound field spatial transformer 150 can transform a quantity of subsets of one or more spatial dimensions of associated sound fields 121 and 123 to form transformed sound fields 121a and 123, whereby at least one spatial dimension is equivalent to, or approximately equal to, the quantity of audio streams. In the example shown, a spatial dimension can refer to the size of sound fields 121 and 123 (e.g., in terms of angles 270° and 90° over which the sound fields span). Thus, sound field spatial transformer 150 can operate to transform the sizes of sound fields 121 and 123 to form transformed sizes for transformed sound fields 121a and 123a. Note that while FIG. 1 depicts two sound fields corresponding to two audio streams, from which two transformed sound fields are formed to span 180°, the various embodiments are not so limited. For example, transformed reproduced sound field 180a can be composed of more than two transformed sound fields that correspond to more than two locations 102 and 104.

Sizes of portions 108a and 108b of respective sound fields 121a and 123a can also be determined by a quantity of audio sources for each audio stream, according to some examples. In particular, sound field spatial transformer 150 can be configured to size transformed sound fields 121a and 123a as a function of the number of listeners or speaking persons associated therewith. For example, sound field spatial transformer 150 can determine a quantity of audio sources associated with sound field 121, and another quantity of audio sources associated with sound field 123. In diagram 100, there are four audio sources associated with sound field 121 and two audio sources associated with sound field 123. Based on these quantities of audio sources, sound field spatial transformer 150 can adjust one or more spatial dimensions for sound field 121 or sound field 123 to form adjusted spatial dimensions to, for example, establish a size of transformed sound field 121a of transformed sound field 123a. Thus, a size can be determined to be proportional to the quantity of audio sources. For instance, the area for transformed reproduced sound field 180a can be divided by the combined number of audio sources of six (6), as shown in diagram 100. Accordingly, sound field spatial transformer 150 can provide sectors for each perceived audio source and are separated by 60° angles with which to separate six audio sources 112b to 119b. Therefore, transformed sound field 121a can be transformed to span 240° (not shown), whereas transformed sound field 123a can be transformed to span 120° (not shown).

Sound field spatial transformer 150 can transform other spatial dimensions that characterize or influence transformation of sound fields, such as characteristics that describing a region (e.g., a sector) including size (e.g., in terms of one or more radii, or an angle that displaces the radii), and position of an audio source (e.g., in terms of a direction, such as an angle of a ray line relative to a remote reference line 170a or 170b). As shown in diagram 100, position 177a can be described in terms of a direction (e.g., angle 163 relative to remote reference line 170b) of ray line 164a, whereas position 179a can be described in terms of a direction associated with angle 162 of ray line 165a. As such, a direction relative to a remote reference point may be sufficient, at least in some cases, to describe a position. In some instances, a spatial dimension can describe a distance from a position to a remote reference line. For example, a spatial dimension can include a distance between position 177a and reference point 160, as well as a distance between position 179a and reference point 160. In view of the above, positions 177a and 179a can be described in a polar coordinate system with ray lines 164a and 165a representing vectors. Note, however, other implementations of the various examples need not be limited to a polar coordinate system.

Further to the transformation of positions (e.g., relative to one or more coordinate systems), consider that sound field spatial transformer 150 can transform spatial dimensions describing positions 177a and 179a to form transformed sound field 123a that includes positions 177b and 179b. In particular, sound field spatial transformer 150 can adjust the angles 163 and 162 to form angle 163b and 162b, respectively. Therefore, recipient 130 can perceive audio sources 118b and 119b as originating from directions 164b and 165b, respectively. Transformation of spatial dimensions and/or sound fields can be a function of a parameter. Therefore, sound field spatial transformer 150 is configured to select one or more parameters to, for example, determine a size for at least one of either portion 108a or portion 108b, or both, of transformed reproduced sound field 180a. Further, sound field spatial transformer 150 can modify the size of one or both portions 108a and 108b based on the size (e.g., on one or more spatial dimensions). In other examples, sound field spatial transformer 150 is also configured to select one or more parameters to determine which of sound field 121 or sound field 123 portion is to be disposed (or oriented for placement) into which portion 108a or 108b, or in relation to, for example, reference line 170.

In various embodiments, sound field spatial transformer 150 is configured to generate 2D or 3D spatial audio for presentation to an audio space 181 as a transformed reproduced sound field 180a. Media device 106 can include two or more loudspeakers or transducers configured to produce acoustic sound waves to form transformed reproduced sound field 180a, according to various examples. Sound field spatial transformer 150 of media device 106 can control transducers to project sound beams at a point in a region to form audio space 181 at which spatial audio is produced to present transformed reproduced sound field 180a to recipient 130. In some examples, media device 106 can determine the position of audio space 181, and steer at least a subset of the transducers to project the sound beams to the position of audio space 181. Therefore, the subset of transducer can steer spatial audio to any number of positions in a region adjacent media device 106 for presenting transformed reproduced sound field 180a to recipient 130. Note that the shape and size of transformed reproduced sound field 180a is depicted as a circle in FIG. 1, it is not intended to be so limiting. That is, transformed reproduced sound field 180a can be represented by a rectangle/grid-like region of space, or any other shape or coordinate system with which to identify and transform positions at which perceived audio sources can be disposed. Thus, sectors may be replaced by other types of areas, such as rectangular or square areas.

In some cases, an audio stream from media device 120 can include data representing three-dimensional audio originating in sound field 121 relative to media device 120, which can be a binaural audio-receiving device coextensive with reference point 161. Similarly, another audio stream can originate from media device 122. However, sound field spatial transformer 150 is not limited to receiving binaural or spatial audio. For example, sound field spatial transformer 150 can convert stereo signals (e.g., a left channel and right channel) into spatial audio for producing transformer reproduced sound field 180a. Therefore, media devices 120 and/or 122 need not be required to include sound field spatial transformer 150 to produce transformed reproduced sound field 180a, at least in some examples. According to some embodiments, the term “reproduced sound field” can refer, in some examples, to spatial audio (e.g., 3-D audio) that is produced such that perceived audio sources are positioned substantially similar to the positions for remote audio sources in the original sound field. According to some embodiments, the term “transformed sound field” can refer, in some examples, to audio produced in a manner that a recipient can detect that perceived audio sources are positioned differently than those positions for remote audio sources in the original sound field (e.g., to due to transformation of spatial dimensions). Further, a transformed sound field can also refer to transformed sound fields based on reproduced sound fields (e.g., spatial audio) or sound fields that include non-spatial audio. To illustrate, consider that three (3) audio streams include three stereo/monaural audio signals from three separate remote locations. A transformed sound field can present the audio so that a recipient can perceive each of the audio signals as originating in, or confined to, in a separate 120° portion (360°/3).

Note that the above-described positions, whether actual (i.e., remote positions) or perceived (i.e., locally reproduced), can also be referred to as “audio space.” According to some example, the term “audio space” can refer to a two- or three-dimensional space in which sounds can be perceived by a listener as 2D or 3D spatial audio. The term “audio space” can also refer to a two- or three-dimensional space from which audio originates, such as a remote audio source being co-located in a remote audio space. For example, recipient 130 can perceive spatial audio in an audio space (not shown), and that same audio space (or variant thereof) can be associated with audio generated by recipient 130, such as during a teleconference. In some cases, the term “audio space” can be used interchangeably with the term “sweet spot.” An audio stream can refer to a collection of audio signals from a common sound field, individual audio signals from a common sound field, or any audio signal from any audio source.

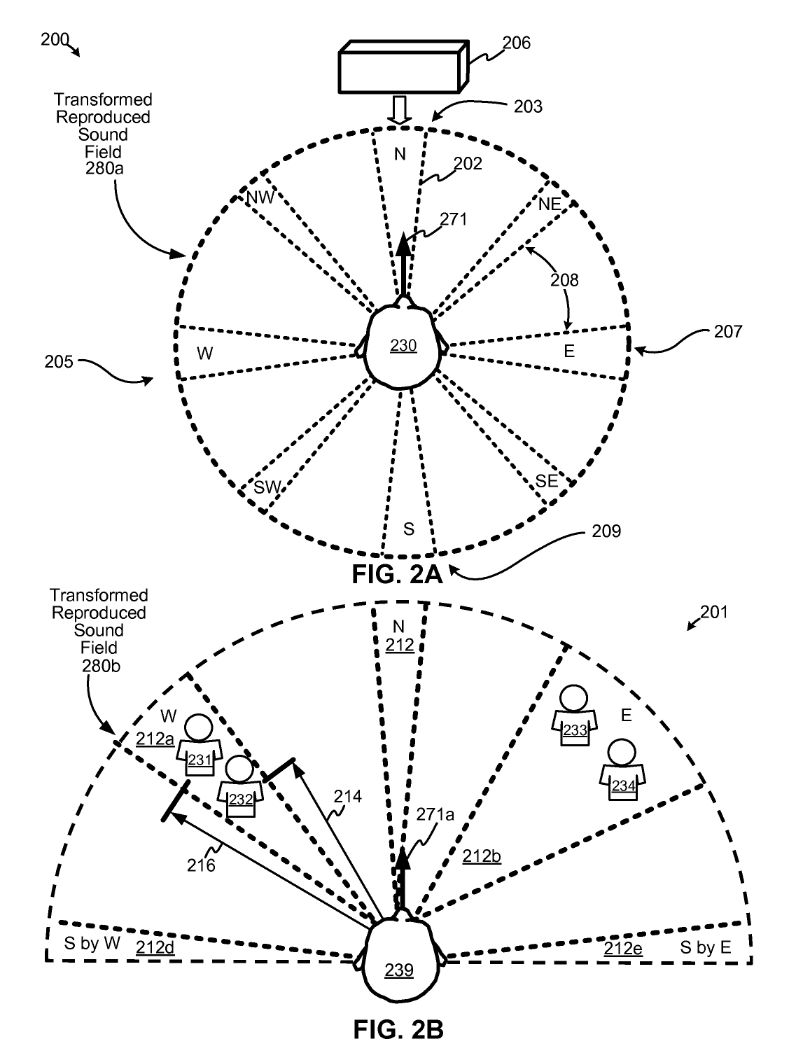

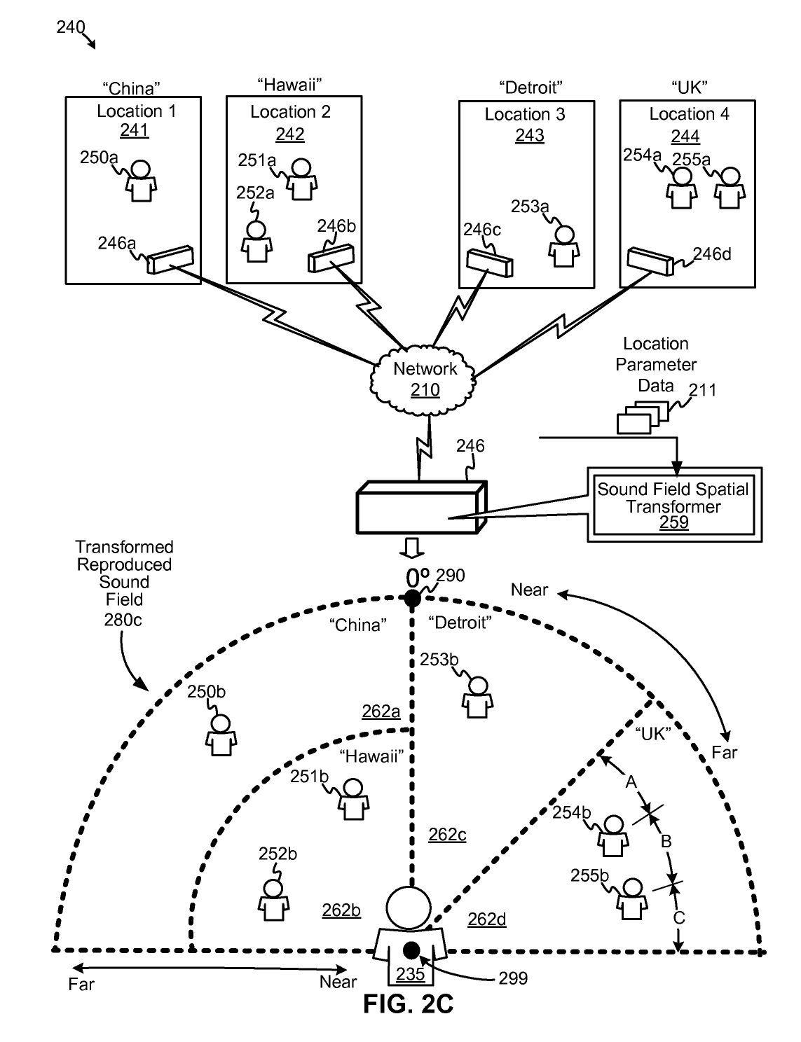

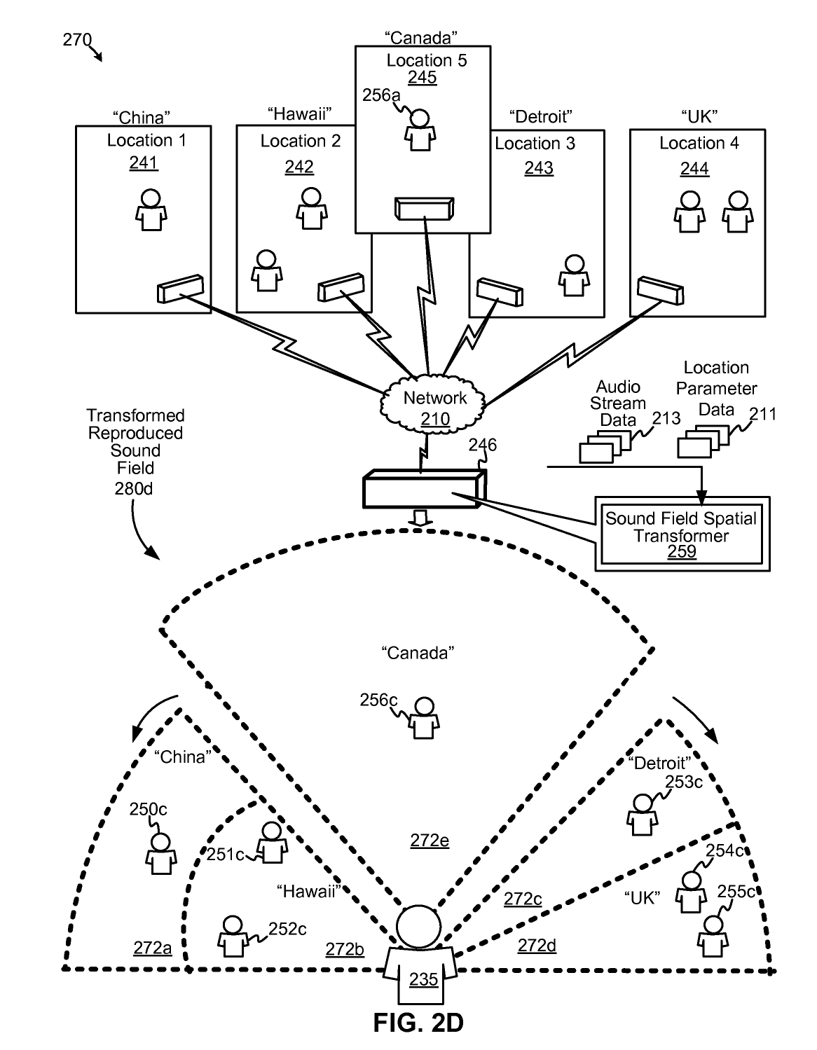

FIGS. 2A and 2B illustrate an example of transformed reproduced sound field (and portions thereof) into which multiple transformed sound fields can be disposed, according to some examples. Diagram 200 of FIG. 2A depicts a media device 206 in accordance with the various examples described herein, whereby media device 206 is configured to implement multiple remote sound fields (not shown) for producing a transformed reproduced sound field 280a, which is presented to immerse a listener 230 in spatial audio (e.g., three-dimensional (“3D”) audio). Diagram 200 further depicts examples of portions of transformed reproduced sound field 280a into which, or at which, transformed sound fields can be disposed relative to the orientation of recipient 230. As shown, the portions can be associated with a sector 202 (e.g., an area spanning a range of degrees) that can it be identified relative to reference line 271. As shown, sector 203 is associated with 0° (i.e., North, or “N”), sector 207 is associated with 90° clockwise relative to reference line 271 (i.e., East, or “E”), sector 209 is associated with 180° (i.e., as South, or “S”), and sector 205 is associated with 270° (i.e., as West, or “W”). While other sectors are identified, such as Southeast, or “SE,” fewer or more may be implemented in other examples. Spaces or other sectors, such as sector 208, also may include transformed sound field. Further to the example shown, North sector 203 is oriented directly in front of recipient 230, while sectors 207 and 205 are disposed directly to the right into the left, respectively, of recipient 230. South sector 209 is directly behind recipient 230. According to some embodiments, transformed reproduced sound field 280a can be formed with two or more collaborative media devices 206 (e.g., one in front of recipient 230 in the other input of recipient 230).

FIG. 2B is a diagram 201 depicting a transformed reproduced sound field 280b having a compressed set of directions with which portions of transformed reproduced sound field 280b can be described. For example, while North sector 212 is shown to be 0° relative to reference line 271a, East sector 212b and West sector 212a are oriented at 45° from reference line 271a rather than 90°. South by West sector 212d can include South sector 209 of FIG. 2A, and is disposed directly to the left of recipient 239 rather than at, for example, 181° clockwise from reference line 271a. Similarly, South by East sector 212e is disposed directly to the right of recipient 239 rather than at, for example, 179° clockwise from reference line 271a. Audio sources, or perceived audio source positions, within sectors of transformed reproduced sound field 280b can be disposed in a variety of arrangements. For example, East sector 212b depicts perceived positions of audio sources 233 and 234 as being equidistant from recipient 239, whereas West sector 212a depicts perceived positions of audio sources 231 and 232 being disposed at different radial distances from recipient 239, such as at radial distance 216 and radial distance 214, respectively. According to some examples, the disposition of audio sources within a sector, as well as the disposition of transformed sound fields 212a and 212b within transformed reproduced sound field 280b, is a function of one or more parameters.

FIGS. 2C and 2D illustrate examples of transformed reproduced sound fields (and portions thereof) into which multiple transformed sound fields can be disposed as a function of location, according to some embodiments. Diagram 240 depicts a media device 246 including a sound field spatial transformer 259 that is configured to receive location parameter data 211 from either internal or external sources, or both. Further, diagram 240 depicts several locations from which media device 246 receives a number of audio streams. For example, media device 246 can receive audio streams from media device 246a, media device 246b, media device 246c, and media device 246d disposed at or in location (“1”) 241 (e.g., “China”), location (“2”) 242 (e.g., “Hawaii”), location (“3”) 243 (e.g., “Detroit”), and location (“4”) 244 (e.g., the “UK”), respectively. In this example, a recipient 235, who is located in California, U.S.A., is positioned at a reference point 299 at which media device 246 presents a transformed reproduced sound field 280c. Further, audio source 250a is disposed at a position adjacent media device 246a, audio sources 251a and 252a are disposed at positions adjacent media device 246b, audio source 253a is disposed at a position adjacent media device 246c, and audio sources 254a and 255a are disposed at positions adjacent media device 246d. Examples of location parameter data 211 include, but are not limited to, location data associated with an IP address associated with a location, an identifier associated with one of media devices 246a to 246d, such as a MAC address or a telephone number, or any other type of data representing the identified location.

According to some examples, sound field spatial transformer 259 can be configured to dispose transformed sound fields associated with locations 241 to 244 into portions of transformed reproduced sound field 280c as a function of the displacement and/or direction of each of the above-identified locations relative to reference point 299. As shown, China and Hawaii are West of the location at which recipient 235 is located, whereas Detroit and the UK are located to the East. In the example shown, sound field spatial transformer 259 is configured to dispose transformed sound fields associated with China and Hawaii to the left of recipient 235 (e.g., to the left to a reference line formed between point 290 and point 299), and to dispose transformed sound fields associated with Detroit and the UK to the right of recipient 235 and the same reference line between point 290 and point 299. Further, sound field spatial transformer 259 is also configured to determine that China and the UK are located at greater distances from point 299 than Hawaii and Detroit, respectively.

Sound field spatial transformer 259 is configured to dispose transformed sound fields associated with the locations in a variety of ways. For example, consider that sound field spatial transformer 259 can dispose transformed sound fields associated with closer geographic locations (relative to the geographic location of recipient 235) in portions of transformed reproduced sound field 280c that are closer to, for example, the reference line formed by points 290 and 299. In particular, locations that are nearer to recipient 235 are disposed nearer a line between points 290 and 299, whereas locations that are farther from recipient 235 are disposed farther away from the line between points 290 and 299. As shown, Detroit is closer to California than the UK, and, as such, the transformed sound field associated with location 243 is disposed in portion 262c of transformed reproduced sound field 280c, whereas the transformed sound field associated with location 244 is disposed in portion 262d, which is farther from the line between points 290 and 299. The positions of remote audio sources 253a, 254a, and 255a can be disposed in corresponding portions 262c and 262d at positions related to perceived distances and/or directions relative to receipt 235. As shown, perceived audio sources 253b, 254b, and 255b can be disposed at similar distances (e.g., equidistant radial distances from point 299), and, in some cases, each of the perceived audio sources 253b to 255b can be positioned to provide optimal distances (e.g., arcuate distances or arc lengths) between perceived audio sources. For example, perceived audio source 253b can be disposed in the middle of portion 262c, and perceived audio sources 254b and 255b can be positioned or distributed such that arc lengths A, B, and C are similar or substantially similar. Note, however, perceived audio sources 253b, 254b, and 255b can be disposed anywhere in respective portions 262c and 262d.

As another example, consider that sound field spatial transformer 259 can dispose transformed sound fields associated with closer geographic locations (relative to the geographic location of recipient 235) in portions of transformed reproduced sound field 280c that are closer to, for example, point 299. Therefore, sound field spatial transformer 259 can cause generation of spatial audio such that recipient 235 perceives audio sources 251b and 252b associated with location 242 (“Hawaii”) as being perceived as closer than audio source 250b associated with location 241 (“China”). As shown, perceived audio sources 251b and 252b are disposed in portion 262b at shorter radial distances than perceived audio source 250b, which is disposed in portion 262a at a greater radial distance from point 299. In various embodiments, perceived audio sources 250b, 251b, and 252b may be disposed in corresponding portions 262a and 262b in any arrangement. In some cases, perceived audio sources 250b, 251b, and 252b may be disposed in a manner to provide sufficient spacing to enable recipient 235 to optimally determine the direction from which a perceived sound or voice emanates. In one example, perceived audio source 250b is disposed in a direction that is interleaved between perceives audio sources 251b and 252b. In some examples, perceived audio sources 251b and 252b are disposed in portion 262b at positions that preserve the physical relationships and positions of audios sources 251a and 252a (e.g., relative to each other) in a sound field associated with media device 246.

FIG. 2D illustrate an examples of dynamically transforming reproduced sound fields (and portions thereof) into one or more transformed sound fields can be added or removed as a function of location, according to some embodiments. Diagram 270 includes similarly-named and similarly-numbered structures and/or functions as set forth in FIG. 2C, and depicts sound field spatial transformer 259 being configured to dynamically adapt transformed reproduced sound field 280d to include an additional audio stream originating, for example, from location (“5”) 245 (“Canada”) at which a remote audio source 256a is located. Sound field spatial transformer 259 is configured to receive location parameter data 211 and audio stream data 213, which includes, among other things, data indicating an added or new audio stream (e.g., a late participant in a teleconference). Further, sound field spatial transformer 259 is configured to determine the location of a new audio source 256a for inserting a new transformed sound field into portion 272e of transformed reproduced sound field 280d, while adapting or modifying portions 272a, 272b, 272c, and 272d to accommodate the insertion. For example, sound field spatial transformer 259 can be configured to determine a size and location into which a perceived audio source 256c is to be disposed in transformed reproduced sound field 280d. Further, sound field spatial transformer 259 can identify mappings of current locations 214, 242, 243, and 244 to portions 272a, 272b, 272c, and 272d, respectively, to identify portion 272e into which perceived audio source 256c is disposed relative to the other locations. Portions 262a, 262b, 262c, and 262d of FIG. 2C are modified or adapted in size/location/portion to form portions 272a, 272b, 272c, and 272d to accommodate portion 272e. In the example shown, Canada is located north of the present location of California in which recipient 235 resides. Therefore, portion 272e is disposed at an orientation coextensive with 0° or a northerly direction relative to recipient 235.

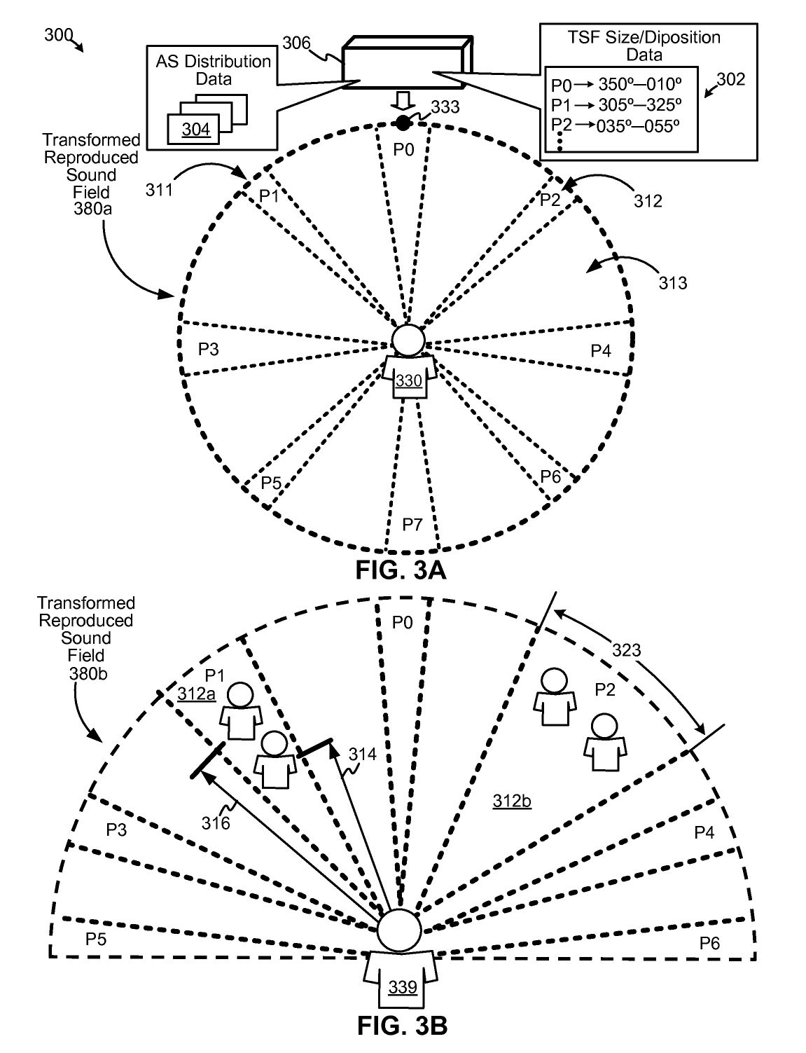

FIGS. 3A and 3B illustrate examples of transformed reproduced sound fields (and portions thereof) into which multiple transformed sound fields can be disposed as a function of one or more parameters, according to some embodiments. Diagram 300 of FIG. 3A depicts a media device 306 configured to reproduce remote sound fields and form a transformed reproduced sound field 380a that includes multiple transformed sound fields. As shown, media device 306 is configured to receive transformed sound field (“TSF”) size/disposition data 302 that can be used to, for example, determine one or more sizes and one or more locations/positions based on one or more values of the one or more parameters. To illustrate, consider that the parameters of diagram 300 describe relative values/characteristics of parameters. That is, size/disposition data 302 indicates that parameter zero (“P0”) is to be disposed between 350° to 10° relative to a line between point 333 and recipient 330. Similarly, transformed sound fields associated with parameters one (“P1”) and two (“P2”) can be disposed at portions 311 (e.g., 305° to 325°) and 312 (e.g., 035° to 055°), respectively. Disposition of other transformed sound fields associated with values of parameters P3, P4, P5, P6, and P7 are also shown, with other values of parameters dispose that other portions of transformed reproduced sound field 380a, such as portion 313. In one example, a client of recipient 330 may be disposed in the position associated with parameter zero (“P0”), whereas the boss and a colleague of recipient 330 are disposed in respective portions associated with parameters P1 and P2. As another example, the parents of recipient 330 may be disposed in a position associated with parameter zero, whereas children and cousins of recipient 330 are disposed in respective portions associated with parameters P1 and P2. In some embodiments, parameter P0 represents a highest priority, which parameters P1 and P2 representing a second priority in a third priority, respectively. Other priorities are also possible.

Media device 306 can also be configured to receive audio source (“AS”) distribution data 304 that describes positions at which to distribute perceived audio sources in a transformed sound field or a portion of transformed reproduced sound field 380b of FIG. 3B, which is an example of an alternatively-sized transformed reproduce sound field. As shown in FIG. 3B, perceived audio sources can be disposed in portion 312a at different radial distances from recipient 339, such as radial distance 314 and radial distance 360. According to various examples, audio source distribution data 304 can specify which audio source this to be associated with which radial distance. For instance, importance of information, a relationship to recipient 339, and other like characteristics can determine a radial distance for a particular perceived audio source. Note that a shorter radial distances 314 may indicate relative importance of information, a closer relationship to recipient 339, a closer geographic relationship to recipient 339, etc. Also, audio source distribution data 304 can specify that perceived audio sources may be disposed at similar radial distances from recipient 339, such as disposed in portion 312b. In some cases, portion 312b can be sized by modifying arc length 323 to accommodate the inclusion of perceived audio sources in portion 312b.

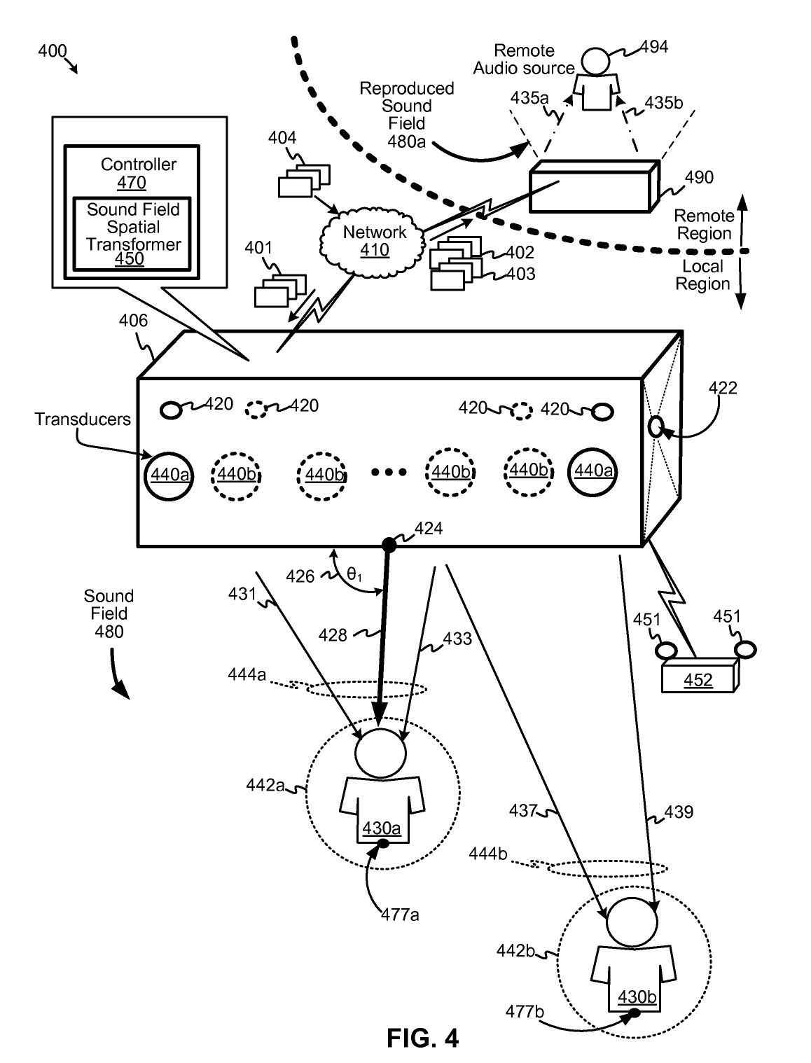

FIG. 4 illustrates an example of a media device configured to form a transformed reproduced sound field based on multiple audio streams associated with different media devices, according to some embodiments. Diagram 400 illustrates a media device 406 configured to at least include one or more transducers 440, a controller 470 including a sound field spatial transformer 450, and various other components (not shown), such as a communications module for communicating, Wi-Fi signals, Bluetooth® signals, or the like via network 410. Media device 406 is configured to receive audio via microphones 420 (e.g., binaural audio) and to produce audio signals and waveforms to produce sound that can be perceived by a remote audio source 494. In some examples, microphones 422 can be implemented in a surface configured to emulate filtering characteristics of, for example, a pinna of an ear. Optionally, a binaural microphone device 452 can implement binaural microphones 451 for receiving audio and generating binaural audio signals that are transmitted via a wireless link to media device 406. Examples of microphones device 452 include a mobile phone, wearable eyewear, headsets, or any other electronic device or wearable device. Therefore, media device 406 can transmit audio data 402 to remote media device 490 as a binaural audio stream. In various embodiments, controller 470 is configured to generate 2D or 3D spatial audio locally, such as at audio space 442a and/or at audio space 442b, based on a sound field associated with a remote audio source 494. Also, controller 470 can facilitate or contribute to the generation of reproduced sound field 480a based on audio received from a sound field 480. According to some embodiments, the remote sound field can be formed as a transformed reproduced sound field (or a reproduce sound field, in some cases) at an audio space 442a and an audio space 442b for local audio sources 430a and 430b, respectively. Note that in some cases, sound field 480 can refer, at least in some examples, to a region from which audio or voices originate (e.g., from local audio sources 430a and 430b), while also receiving propagation of audio and/or sound beams for forming transformed reproduced sound fields based on audio from a remote audio source 494. Similarly, reproduced sound field 480a includes a transformed reproduced sound field that include audio originating from local audio sources 430a and 430b, as well as sound originating from remote audio source 494 that is received by media device 490.

According to some embodiments, media device 406 receives audio data or audio stream data 401 from one or more remote regions that include one or more remote media devices, such as media device 490, or from a media storing the audio (not shown). Audio stream data 404 originates from other remote media devices that are not shown. Controller 470 is configured to use the audio data to generate 2D or 3D spatial audio 444a for transmission to recipient 430a. In some embodiments, transducers 440 can generate first sound beam 431 and second sound beam 433 for propagation to the left ear and the right ear, respectively, of recipient 430a. Therefore, sound beams 431 and 433 are generated to form an audio space 442a (e.g., a binaural audio space) in which recipient 430a perceives spatial audio 444a as a transformed reproduced sound field. Transducers 440 cooperate electrically with other components of media device 406, including controller 470, to steer or otherwise direct sound beams 431 and 433 to a point in space at which listener 440a resides and/or at which audio space 442a is to be formed. In some cases, a single left transducer 440a (or loudspeaker) can generate sound beam 431, and a single right transducer 440a (or loudspeaker) can generate sound beam 433, whereby controller 470 can implement a sound field spatial transformer to generate 3-D spatial audio as a transformed reproduced sound field composed of transformed sound fields from different remote locations. Controller 470 can be configured to generate audio space 442a at position 477a by default, whereas in other examples, controller 470 can be configured to modify directivity of sound beams 431 and 433 by steering transducers 440a to aim at position 477a to provide spatial audio 444a to recipient 430a. In view of the above, transducers 440a may be sufficient to implement a left loudspeaker and a right loudspeaker to direct sound beam 431 and sound beam 433, respectively, to recipient 430a.

According to various other examples, an array of any number of transducers 440a and 440b can be implemented to form sound beams 431 and 433, which can be controlled by controller 470 in a manner that steers sound beams (that can include the same or different audio) to different positions to form multiple groups of spatial audio. For example, controller 470 can receive data representing positions 477a and 477b for recipients 430a and 430b, respectively, and can control directivity of a first subset of transducers 440a and 440b to direct sound beams 431 and 433 to position 477a, as well as the directivity of a second subset of transducers 440a and 440b to direct sound beams 437 and 439 as spatial audio to position 477b. Remote listener 494 can transmit audio that is presented as spatial audio 440a directed to only audio space 442a, whereby other recipients cannot perceive audio 444a since transducers 440 need not propagate audio 444a to other positions, unless recipient 430b moves into audio space 442a. Note that transducers 440b can be implemented along with transducers 440a to form arrays or groups of any number of transducers operable as loudspeakers, whereby the groups of transducers need not be aligned in rows and columns and can be arranged and sized differently, according to some embodiments. Note that while recipients 430a and 430b are described as such (i.e., recipients of audio), recipients 430a and 430b each can be audio sources, too, and can represent the same audio source at different times. In some cases, recipients 430a and 430b need not be animate, but can be audio devices.

Controller 470 can generate spatial audio using a subset of spatial audio generation techniques that implement digital signal processors, digital filters, and the like to provide perceptible cues for recipients 430a and 430b to correlate spatial audio 444a and 444b, respectively, with perceived positions from which the audio originate. In some embodiments, controller 470 is configured to implement a crosstalk cancellation filter (and corresponding filter parameters), or variant thereof, as disclosed in published international patent application W02012/036912A1, which describes an approach to producing cross-talk cancellation filters to facilitate three-dimensional binaural audio reproduction. In some examples, controller 470 includes one or more digital processors and/or one or more digital filters configured to implement a BACCH® digital filter, an audio technology developed by Princeton University of Princeton, N.J. In some examples, controller 470 includes one or more digital processors and/or one or more digital filters configured to implement LiveAudio® as developed by AliphCom of San Francisco, Calif.

According to some embodiments, media device 406 and/or controller 470 can determine or otherwise receive position data describing positions 477a and 477b of recipients 430a and 430b, respectively. Position data can specify relative distances (e.g., magnitudes of vectors) and directions (e.g., angular displacement of vectors relative to a reference) of audio sources and other aspects of sound field 480, including the dimensions of a room and the like. For example, position 477a can be described in terms of a magnitude or a direction of ray line 428 extending from reference point 424 at an angle 426 relative to a front surface of media device 406. In some examples, controller 470 determines distances (and variations thereof) and directions (and variations thereof) for a position of recipient 430a to modify operation of, for example, a cross-talk filter (e.g., angles or directions from transducers 440 to a recipient's ears) and/or steerable transducers to alter directivity of spatial audio toward a recipient 430a in sound field 480.

In some examples, controller 470 can be configured to transmit control data 403 from media device 406 to remote audio system 490. In some embodiments, control data 403 can include information describing, for example, how to form a reproduced sound field 480a. Remote audio system 490 can use control data 403 to reproduce sound field 480 by generating sound beams 435a and 435b for the right ear and left ear, respectively, of remote listener 494. In further examples, control data 403 may include parameters to adjust a crosstalk filter, including but not limited to distances from one or more transducers to an approximate point in space in which a listener's ear is disposed, calculated pressure to be sensed at a listener's ear, time delays, filter coefficients, parameters and/or coefficients for one or more transformation matrices, and various other parameters. Remote listener 494 may perceive audio generated by audio source 430a as originating from a position of audio space 442a relative to, for example, a point in space coinciding with the location of the remote audio system 490. In particular, remote listener 494 can perceive audio sources (e.g., associated with audio sources 430a and 430b) relative to media device 490 in reproduced sound field 480a.

In some cases, remote audio system 490 includes logic, structures and/or functionality similar to that of controller 470 of media device 406. But in some cases, remote audio system 490 need not include a controller. As such, controller 470 can generate spatial audio that can be perceived by remote listener 494 regardless of whether remote audio system 490 includes a controller. That is, remote audio system 490, which can provide binaural audio, can use audio data 402 to produce spatial binaural audio via, for example, sound beams 435a and 435b without a controller, according to some embodiments. In some embodiments, media device 490 can receive audio data 404 as well as other control data from other media devices (not shown) to present sound beams 435a and 435b as a transformed reproduced sound field including a transformed version of sound field 480. Alternatively, controller 470 of media device 406 can used control data, similar to control data 403, to generate spatial audio 444a and 444b by receiving audio from remote audio system 490 (e.g., need not be similar to media device 406) and applying control data to reproduce the sound field associated with the remote listener 494 for recipient 430a. A controller (not shown) disposed in remote audio system 490 can generate the control data, which is transmitted as part of audio data 401. In some cases, the controller disposed in remote audio system 490 can generate the spatial audio to be presented to recipient 430a regardless of whether media device 406 includes controller 470. That is, the controller disposed in remote audio system 490 can generate the spatial audio in a manner that the spatial effects can be perceived by a listener 440 via any audio presentation system configured to provide binaural audio.

Examples of components or elements of an implementation of media device 406, including those components used to determine proximity of a listener (or audio source), are disclosed in U.S. patent application Ser. No. 13/831,422, entitled “Proximity-Based Control of Media Devices,” filed on Mar. 14, 2013 with Attorney Docket No. ALI-229, which is incorporated herein by reference. In various examples, media device 406 is not limited to presenting audio, but rather can present both visual information, including video (e.g., using a pico-projector digital video projector or the like) or other forms of imagery along with (e.g., synchronized with) audio. According to at least some embodiments, the term “audio space” can refer to a two- or three-dimensional space in which sounds can be perceived by a listener as 2D or 3D spatial audio. The term “audio space” can also refer to a two- or three-dimensional space from which audio originates, whereby an audio source can be co-located in the audio space. For example, a listener can perceive spatial audio in an audio space, and that same audio space (or variant thereof) can be associated with audio generated by the listener, such as during a teleconference. The audio space from which the audio originates can be reproduced at a remote location as part of reproduced sound field 480a. In some cases, the term “audio space” can be used interchangeably with the term “sweet spot.” In at least one non-limiting implementation, the size of the sweet spot can range from two to four feet in diameter, whereby a listener can vary its position (i.e., the position of the head and/or ears) and maintain perception of spatial audio. Various examples of microphones that can be implemented as microphones 420 and 451 include directional microphones, omni-directional microphones, cardioid microphones, Blumlein microphones, ORTF stereo microphones, binaural microphones, arrangements of microphones (e.g., similar to Neumann KU 100 binaural microphones or the like), and other types of microphones or microphone systems.

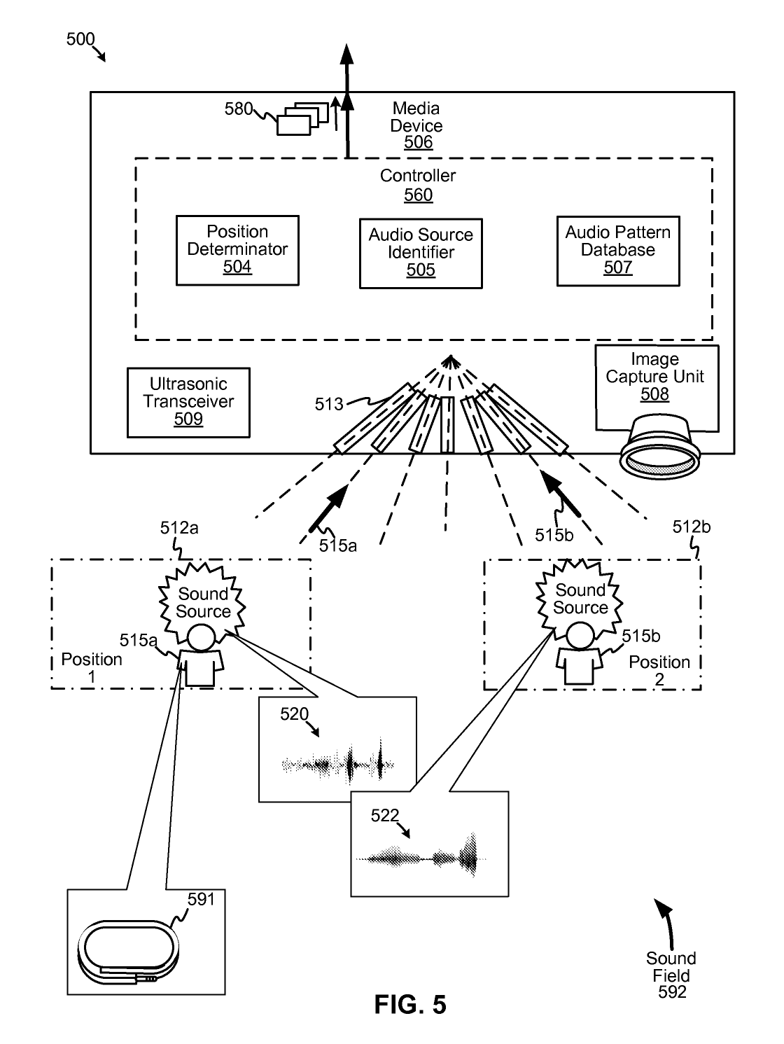

FIG. 5 depicts an example of a media device including a controller configured to determine position data and/or identification data regarding one or more audio sources, according to some embodiments. In this example, diagram 500 depicts a media device 506 including a controller 560, an ultrasonic transceiver 509, an array of microphones 513, and an image capture unit 508, any which may be optional. Controller 560 is shown to include a position determinator 504, an audio source identifier 505, and an audio pattern database 507. Position determinator 504 is configured to determine a position 512a of an audio source 515a, and a position 512b of an audio source 515b. In some embodiments, position determinator 504 is configured to receive position data from a wearable device 591 which may include a geo-locational sensor (e.g., a GPS sensor) or any other position or location-like sensor. An example of a suitable wearable device, or a variant thereof, is described in U.S. patent application Ser. No. 13/454,040, which is incorporated herein by reference. In other examples, position determinator 504 can implement one or more of ultrasonic transceiver 509, array of microphones 513, and image capture unit 508.

Ultrasonic transceiver 509 can include one or more acoustic probe transducers (e.g., ultrasonic signal transducers) configured to emit ultrasonic signals to probe distances and/or locations relative to one or more audio sources in a sound field. Ultrasonic transceiver 509 can also include one or more ultrasonic acoustic sensors configured to receive reflected acoustic probe signals (e.g., reflected ultrasonic signals). Based on reflected acoustic probe signals (e.g., including the time of flight, or a time delay between transmission of acoustic probe signal and reception of reflected acoustic probe signal), position determinator 504 can determine positions 512a and 512b. Examples of implementations of one or more portions of ultrasonic transceiver 509 are set forth in U.S. Nonprovisional patent application Ser. No. 13/954,331, filed Jul. 30, 2013 with Attorney Docket No. ALI-115, and entitled “Acoustic Detection of Audio Sources to Facilitate Reproduction of Spatial Audio Spaces,” and U.S. Nonprovisional patent application Ser. No. 13/954,367, filed Jul. 30, 2013 with Attorney Docket No. ALI-144, and entitled “Motion Detection of Audio Sources to Facilitate Reproduction of Spatial Audio Spaces,” each of which is herein incorporated by reference in its entirety and for all purposes.

Image capture unit 508 can be implemented as a camera, such as a video camera. In this case, position determinator 504 is configured to analyze imagery captured by image capture unit 508 to identify sources of audio. For example, images can be captured and analyzed using known image recognition techniques to identify an individual as an audio source. Based on the relative size of an audio source in one or more captured images, position determinator 504 can determine an estimated distance relative to image capture unit 508. Further, position determinator 504 can estimate a direction based on the portion in which the audio sources captured relative to the field of view (e.g., potential audio source captured in a right portion of the image can indicate the audio source may be in the direction of approximately 60 to 90° to a normal vector).

Microphones in array of microphones 513 can each be configured to detect or pick-up sounds originating at a position. Position determinator 504 can be configured to receive acoustic signals from each of the microphones or directions from which a sound, such as speech, originates. For example, a first microphone can be configured to receive speech originating in a direction 515a from a sound source at position 512a, whereas a second microphone can be configured to receive sound originating in a direction 515b from a sound source at position 512b. For example, position determinator 504 can be configured to determine the relative intensities or amplitudes of the sounds received by a subset of microphones and identify the position (e.g., direction) of a sound source based on a corresponding microphone receiving, for example, the greatest amplitude. In some cases, a position can be determined in three-dimensional space. Position determinator 504 can be configured to calculate the delays of a sound received among a subset of microphones relative to each other to determine a point (or an approximate point) from which the sound originates. Delays can represent farther distances a sound travels before being received by a microphone. By comparing delays and determining the magnitudes of such delays, in, for example, an array of transducers operable as microphones, the approximate point from which the sound originates can be determined. In some embodiments, position determinator 504 can be configured to determine the source of sound by using known time-of-flight and/or triangulation techniques and/or algorithms.

Audio source identifier 505 is configured to identify or determine identification of an audio source. In some examples, an identifier specifying the identity of an audio source can be provided via a wireless link from wearable device, such as wearable device 591. According to some other examples, audio source identifier 505 is configured to match vocal waveforms received from sound field 592 against voice-based data patterns in an audio pattern database 507. For example, vocal patterns of speech received by media device 506, such as patterns 520 and 522, can be compared against those patterns stored in audio pattern database 507 to determine the identities audio source 515a and 515b, respectively, upon detecting a match. By identifying an audio source, controller 560 can transform a position of the specific audio source, for example, based on its identity and other parameters, such as the relationship to recipient of spatial audio. Therefore, audio sources can be positioned differently in a transformed sound field than the arrangement in the original sound field.

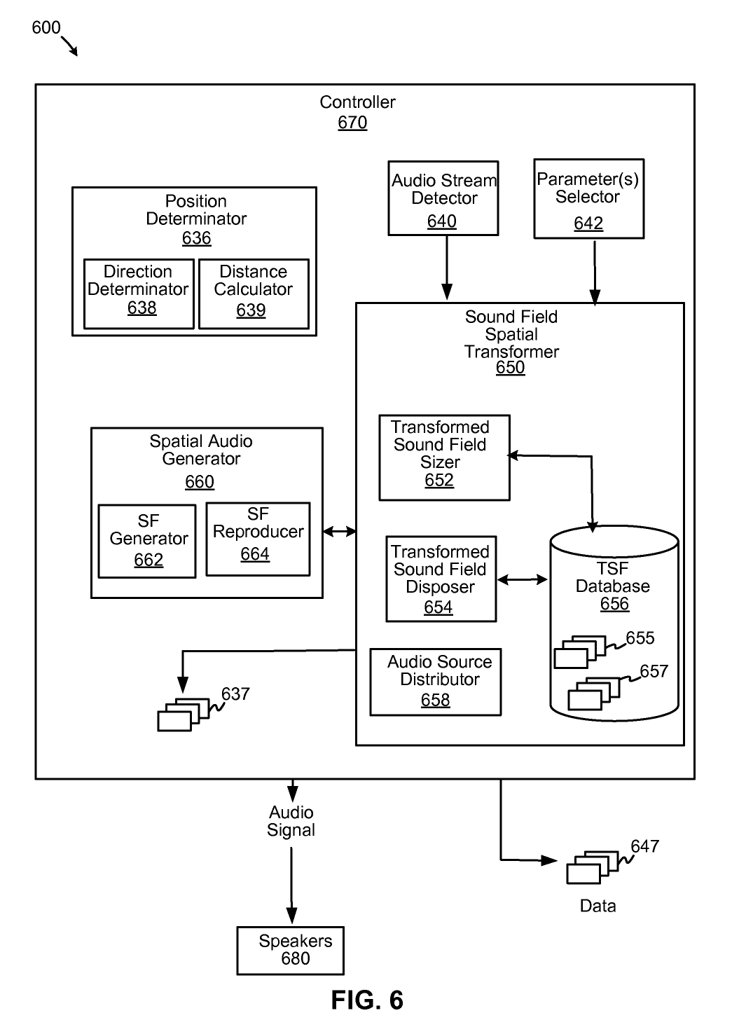

FIG. 6 is a diagram depicting an example of a controller implementing a sound field spatial transformer, according to some embodiments. Diagram 600 is shown to include a position determinator 636, an audio stream detector 640, a parameter selector 642, a spatial audio generator 660, and a sound field spatial transformer 650. Position determinator 636 includes a direction determinator 638 and distance calculator 639. In some examples, direction determinator 638 may be configured to determine a direction associated with a particular received acoustic signal, such as voiced audio signals. A corresponding direction (or angle) can be determined from which the audio originates (e.g., using techniques such as based on position determinator 504 of FIG. 5). Distance calculator 639 can be configured to calculate an approximate distance (or radial distance) to an audio source using, for example, techniques described in relation with position determinator 504 of FIG. 5. In some examples, spatial audio generator 660 may optionally include a sound field (“SF”) generator 662 and/or a sound field (“SF”) reproducer 664. Sound field generator 662 can generate spatial audio based on audio received from microphones disposed in or otherwise associated with a local media device, whereby the spatial audio can be transmitted as audio data 647 to a remote location. Sound field reproducer 664 can receive audio data from a remote sound field, as well as control data (e.g., including spatial filter parameters for a cross-talk cancellation filter and other circuitry), for converting audio received from a remote location (or a recorded medium) into spatial audio for transmission through speakers 680 to local listeners.

Audio stream detector 640 is configured to detect a quantity of audio streams at any specific point in time, and also determine a number of audio sources that are added or deleted from a collaborative communication, such as a teleconference. In some cases, the quantity of audio streams can be used by sound field spatial transformer 650 to determine a number of transformed sound fields, and, thus, a number of portions of a transformed reproduce sound field into which the transformed sound fields are to be disposed. Parameter selector 642 is configured to select one or more parameters such as a location parameter, a relationship parameter, and importance-level parameter, and the like, whereby any of the parameters may be prioritized relative to each other. For example, a relationship parameter defining a relation between the recipient and remote audio sources may be used to determine the size and disposal of transform sound fields over location parameters, as an example.

Sound field spatial transformer 650 is shown to include transformed sound field sizer 652, a transformed sound field disposer 654, an audio source distributor 658, and a transformed sound field (“TSF”) database 656. Sound field spatial transformer 650 is configured to transform individual sound fields and combine them to form, for example, a unitary transformed reproduced sound field. Transformed sound field sizer 652 is configured to modify the size for a transformed sound field as a function of one or more parameters including a quantity of audio streams that are detected by audio stream detector 640. In some examples, a transformed sound field size can be sized proportionate to the number of audio sources disposed therein (e.g., higher quantities of audio sources associated with a transformed sound field can lead to an increased size). In some embodiments, one or more head related transfer functions (“HRTFs”) and coefficients thereof, as well as other related data, can be modeled and interpolated to, for example, scale distance relationships between reproduced audio sources (e.g., virtual audio sources). As example, azimuth and elevation angles, as well as interaural time differences (“ITDs”) and interaural level differences (“ILD”), among other parameters (e.g., HRTF parameters), can be modeled and scaled to mimic or otherwise transform a reproduced sound field with the size perceptibly different than in the original sound field. Transformed sound field sizer 652 can implement HRTF-related filters (e.g., FIR filters and coefficients) and transforms (e.g., Fourier transforms) to produce perceived audio sources in a transformed sound field that is sized differently than the original sound field. Transformed sound field sizer 652 can access size definition data 655 in database 656, whereby size definition data 655 includes data describing the effect of different parameter data on changing the size of a transformed sound field. In some cases, modification of size may be based on multiple parameters each of which are weighted in accordance with weighted values defined in size definition data 655.

Audio source distributor 658 is configured to distribute audio sources in a portion of a transformed reproduced sound field either at equal arc lengths circumferentially about a portion of a circle encompassing a recipient of audio, or at different radial distances from the recipient. In some examples, data modeled with an HRTF can be transformed from a head-based coordinate system (e.g., in which azimuth angles, elevation angles, ITDs, and ILDs, among other HRTF parameters, are modeled relative to a point of perceived sound origination from two ears of a head) to a transformed sound field coordinate system referenced to another point of sound origination in a region external to a media device. As such, audio source distributor 658 can modify the position of a perceived audio source (e.g., described in terms of a first coordinate system) to a transformed sound field (e.g., described in a second coordinate system) so that controller 670 can modify the perceived position from which an audio source projects a sound in a portion of the transformed reproduced sound field.

Transformed sound field disposer 654 is configured to transform or otherwise reorient perceived directions of perceived audio sources for a reproduced sound field to another orientation such that a recipient perceives audio originating from directions different than that captured at a remote sound field. For example, if audio sources are perceived to originate at 60° from a normal vector in a remote sound field, transformed sound field disposer 654 can be configured to dispose a transformed version of the original sound field (e.g., “transformed sound field”) in a region local to a recipient (e.g., in a portion of the transformed reproduced sound field) such that the recipient perceives audio originating from a different direction other than 60°. In some examples, transformed sound field disposer 654 can perform transforms from a head-based coordinate system to a transformed sound field coordinate system (e.g., relative to a reference point on a media device). Transformed sound field disposer 654 can access location definition data 657 in database 656, whereby location definition data 657 includes data describing the effect of different parameter data on disposing or otherwise locating a transformed sound field relative to a reference line or a reference point. In some cases, a location at which the transformed sound field is disposed may be based on multiple parameters each of which are weighted in accordance with weighted values defined in location definition data 657.

Therefore, sound field spatial transformer 650 is configured generate transformed reproduce sound field data 637 which is configured to project spatial audio via speakers 682 recipient.

In view of the foregoing, the functions and/or structures of a media device or a sound field spatial transformer 650, as well as their components, can facilitate the determination of positions of audio sources (e.g., listeners) and sizes of transformed reproduced sound field portions, thereby enabling a local listener to aurally identify groups of remote audio sources as well as individual remote audio sources based on, for example, position at which a perceived audio source is disposed.

In some embodiments, sound field spatial transformer 650 can be in communication (e.g., wired or wirelessly) with a mobile device, such as a mobile phone or computing device. In some cases, a mobile device or any networked computing device (not shown) in communication with a media device including sound field spatial transformer 650 can provide at least some of the structures and/or functions of any of the features described herein. As depicted in FIG. 6 and other figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 6 (or any figure) can represent one or more algorithms. Or, at least one of the elements can represent a portion of logic including a portion of hardware configured to provide constituent structures and/or functionalities.

For example, controller 670 and any of its one or more components, such as position determinator 636, audio stream detector 640, parameter selector 642, spatial audio generator 660, and sound field spatial transformer 650 can be implemented in one or more computing devices (i.e., any audio-producing device, such as desktop audio system (e.g., a Jambox® implementing LiveAudio® or a variant thereof), a mobile computing device, such as a wearable device or mobile phone (whether worn or carried), that include one or more processors configured to execute one or more algorithms in memory. Thus, at least some of the elements in FIG. 6 (or any figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, controller 670 and any of its one or more components, such as position determinator 636, audio stream detector 640, parameter selector 642, spatial audio generator 660, and sound field spatial transformer 650 can be implemented in one or more computing devices that include one or more circuits. Thus, at least one of the elements in FIG. 6 (or any figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

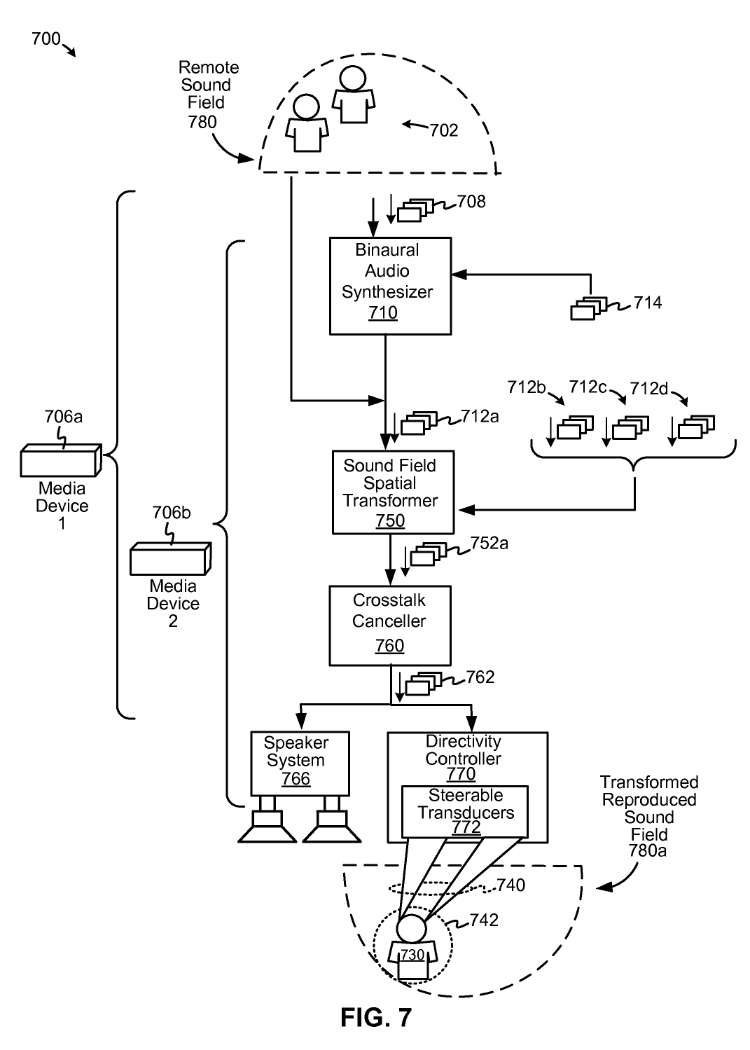

FIG. 7 is a diagram depicting a functional block diagram illustrating the distribution of structures and/or functionality, according to some embodiments. Diagram 700 depicts a remote sound field 780 including audio sources 702. Further to FIG. 7, diagram 700 includes a binaural audio synthesizer 710, a sound field spatial transformer 750, a crosstalk canceler 760, a speaker system 766, and the directivity controller 770 for controlling steerable transducers 772. In the example shown, a first media device 706a can include audio signals 708, a binaural audio synthesizer 710, a sound field spatial transformer 750 and a crosstalk canceler 760, or fewer components, according to various implementations. Further, a second media device 706b can include binaural audio synthesizer 710, a sound field spatial transformer 750, a crosstalk canceler 760, and one or both of speaker system senses six and directivity controller 770, or fewer components, according to various implementations. Speaker system 766 includes a left speaker and a right speaker, and steerable transducers 770 include an array of transducers, any of which can generate sound beams, such as sound beams 740 to form an audio space 742 for recipient 730, whereby audio space 742 provides for a transformed reproduced sound field 780a. As such, recipient 730 perceives audio sources 702 and other audio sources (not shown) in transformed reproduced sound field 780a at different locations in, or different portions of, transformed reproduced sound field 780a. Either first media device 706a or second media device 706b can be implemented as a local or remote media device. Therefore, the structures and/or functionalities of at least binaural audio synthesizer 710, a sound field spatial transformer 750, and a crosstalk canceler 760 can be distributed in or over one or more media devices 706a and 706b.

Audio data 708 can include binaural audio signals, stereo audio signals, and, in some cases, monaural audio signals. According to one example, binaural audio synthesizer 710 implements a head-related transfer function (“HRTF”) to encode a binaural audio signal based on, for example, a stereo signal or a monaural signal. Binaural audio synthesizer 710 can receive data 714, which can include one or more subsets of HRTF-related coefficients or parameters that can be implemented for each recipient 730 in transformed reproduce sound field 780a. For example, data 714 can include specific physical dimensions of recipient 730, including ear-related dimensions. Binaural audio signals 712a is transmitted to sound field spatial transformer 750, which is also configured to receive audio data 712b to 712d from other remote audio sources and/or remote sound fields.

Sound field spatial transformer 750 is configured to generate data 752a representing spatial audio for implementing a transformed reproduced sound field. Data 752a can be transmitted to crosstalk canceler 760, which is configured to implement a crosstalk cancellation filter, such as described above, based on, for example, a position of recipient 730. In view of the foregoing, one of media devices 706a and 706b can implement binaural audio synthesizer 710, a sound field spatial transformer 750, a crosstalk canceler 760, a speaker system 766, and the directivity controller 770. As such, a remote media device need not be configured to receive binaural audio from remote audio sources 702. Note that in some embodiments, sound field spatial transformer 750 includes binaural audio synthesizer 710 and crosstalk canceler 760.

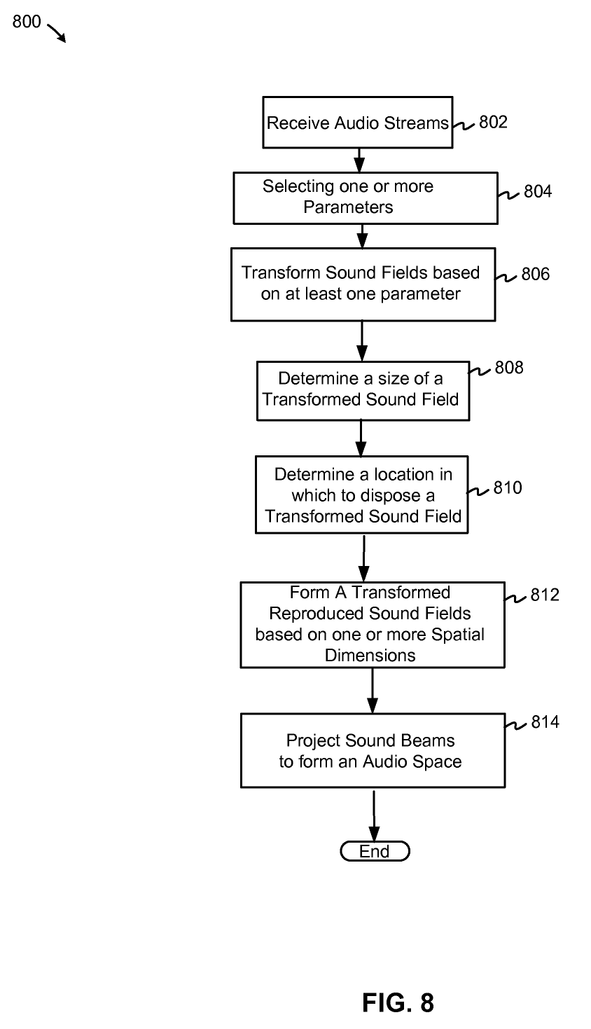

FIG. 8 is an example flow of performing transformation of sound fields, according to some embodiments. Flow 800 starts by receiving multiple audio streams at 802 each audio stream representing one or more remote audio sources for a particular remote sound field. At 804, one or more parameters are selected. For example, a location parameter can be selected, and importance-level parameter can be selected, a relationship parameter can be selected, and other like parameters can be selected, as well as associated priorities for each of the parameters so multiple parameters can be applied in weighted fashion. At 806, sound fields from corresponding remote locations are transformed based on at least one parameter such as location, and sizes of transformed sound fields can be determined at 808. At 810, a location into which a transformed sound field is to be disposed can be determined. Further, other locations or portions of transformed reproduced sound field can also be determined. At 812, a transformed reproduced sound field is formed based on one or more spatial dimensions. Flow 800 continues to 814 at which sound beams are projected to form an audio space for presenting a transformed reproduced sound field to a recipient adjacent, for example, a media device implementing a sound field spatial transformer, according to various examples.

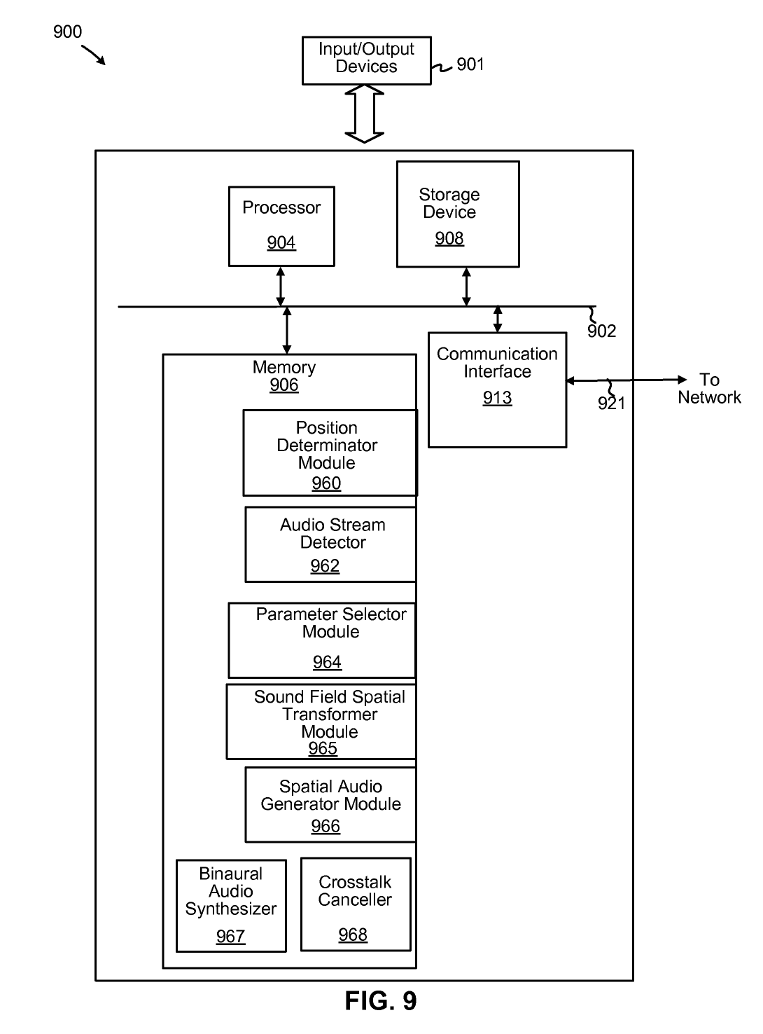

FIG. 9 illustrates an exemplary computing platform disposed in a media device in accordance with various embodiments. In some examples, computing platform 900 may be used to implement computer programs, applications, methods, processes, algorithms, or other software to perform the above-described techniques. Computing platform 900 includes a bus 902 or other communication mechanism for communicating information, which interconnects subsystems and devices, such as processor 904, system memory 906 (e.g., RAM, etc.), storage device 908 (e.g., ROM, etc.), a communication interface 913 (e.g., an Ethernet or wireless controller, a Bluetooth controller, etc.) to facilitate communications via a port on communication link 921 to communicate, for example, with a computing device, including mobile computing and/or communication devices with processors. Processor 904 can be implemented with one or more central processing units (“CPUs”), such as those manufactured by Intel® Corporation, or one or more virtual processors, as well as any combination of CPUs and virtual processors. Computing platform 900 exchanges data representing inputs and outputs via input-and-output devices 901, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 900 performs specific operations by processor 904 executing one or more sequences of one or more instructions stored in system memory 906, and computing platform 900 can be implemented in a client-server arrangement, peer-to-peer arrangement, or as any mobile computing device, including smart phones and the like. Such instructions or data may be read into system memory 906 from another computer readable medium, such as storage device 908. In some examples, hard-wired circuitry may be used in place of or in combination with software instructions for implementation. Instructions may be embedded in software or firmware. The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks and the like. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by computing platform 900. According to some examples, computing platform 900 can be coupled by communication link 921 (e.g., a wired network, such as LAN, PSTN, or any wireless network) to any other processor to perform the sequence of instructions in coordination with (or asynchronous to) one another. Computing platform 900 may transmit and receive messages, data, and instructions, including program code (e.g., application code) through communication link 921 and communication interface 913. Received program code may be executed by processor 904 as it is received, and/or stored in memory 906 or other non-volatile storage for later execution.

In the example shown, system memory 906 can include various modules that include executable instructions to implement functionalities described herein. In the example shown, system memory 906 includes a position determinator module 690, an audio stream detector 962, a parameter selector module 964, a sound field spatial transformer module 695, a spatial audio generator module 966, a binaural audio synthesizer 967, and a crosstalk canceller 968, each of which can be configured to provide one or more functions described herein.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving a first audio stream including data representing audio originating from a first subset of one or more audio sources at positions in a first sound field relative to a first reference point;
receiving a second audio stream including data representing audio originating from a second subset of one or more audio sources in a second sound field at positions relative to a second reference point;
transforming at a processor a first subset of one or more spatial dimensions of the first sound field to form a first transformed sound field;
transforming at the processor a second subset of one or more spatial dimensions of the second sound field to form a second transformed sound field;
forming a transformed reproduced sound field in which the first transformed sound field is disposed in a first portion of the transformed reproduced sound field, and the second transformed sound field is disposed in a second portion of the transformed reproduced sound field; and
causing transducers to project sound beams at a point in a region at which spatial audio is produced to present the transformed reproduce sound field to an audio space.

2. The method of claim 1, further comprising:
selecting a subset of one or more parameters to determine a size for at least one of the first portion of the transformed reproduced sound field and the second portion of the transformed reproduced sound field; and
sizing the at least one of the first portion of the second portion based on the size.

3. The method of claim 1, further comprising:
selecting a subset of one or more parameters to determine one of the first transformed sound field and the second transformed sound field to dispose into one of the first portion or the second portion of the transformed reproduced sound field.

4. The method of claim 1, further comprising:
selecting one or more of a location parameter, a relationship parameter, and an importance level parameter to determine one of the first transformed sound field and the second transformed sound field to form a determined transformed sound field; and
disposing the determined transformed sound field into one of the first portion or the second portion of the transformed reproduced sound field.

5. The method of claim 1, further comprising:
determining a quantity of audio streams including the first and the second audio streams, each originating in association with one of a plurality of reference points including the first reference point and the second reference point; and
transforming a quantity of subsets of one or more spatial dimensions of associated sound fields to form transformed sound fields,
wherein the quantity of subsets of the one or more spatial dimensions is equivalent to the quantity of audio streams.

6. The method of claim 1, wherein forming the transformed reproduced sound field comprises:
determining a reference line associated with the point in the region;
disposing the first portion of the transformed reproduced sound field relative to the reference line as a function of data representing one or more parameter values; and
disposing the second portion of the transformed reproduced sound field relative to the reference line as a function of the data representing the one or more parameter values.

7. The method of claim 6, further comprising:
disposing either the first portion or the second portion of the transformed reproduced sound field at a predetermined portion based on a value of a prioritized parameter of the one or more parameter values.

8. The method of claim 6, further comprising:
determining a first range of parameter values for a parameter associated with the first portion of the transformed reproduced sound field;
determining a second range of parameter values for the parameter associated with the second portion of the transformed reproduced sound field;
prioritizing the first portion of the transformed reproduced sound over the second portion of the transformed reproduced sound based on the first range of parameter values relative to the second range of parameter values; and
disposing the first portion of the transformed reproduced sound field at or between an anterior portion of the transformed reproduced sound field and the second portion of the transformed reproduced sound field.

9. The method of claim 6, further comprising:
determining a first range of parameter values for a parameter associated with the first portion of the transformed reproduced sound field;
determining a second range of parameter values for the parameter associated with the second portion of the transformed reproduced sound field;
prioritizing the first portion of the transformed reproduced sound over the second portion of the transformed reproduced sound based on the first range of parameter values relative to the second range of parameter values; and
disposing the first portion of the transformed reproduced sound field at a first radial distance relative to the point; and
disposing the second portion of the transformed reproduced sound field at a second radial distance relative to the point.

10. The method of claim 9, wherein the first radial distance is less than the second radial distance.

11. The method of claim 1, further comprising:
determining a quantity of audio sources in the first subset of one or more audio sources or the second subset of one or more audio sources; and
adjusting the one or more spatial dimensions for the first sound field or the second sound field to form one or more adjusted spatial dimensions to establish a size of the first transformed sound field or the second transformed sound field;
wherein the size is configured to include the quantity of audio sources.

12. The method of claim 11, further comprising:
distributing the positions of the audio sources associated with the first sound field or the second sound field to be substantially equidistant in the first transformed sound field or the second transformed sound field.

13. The method of claim 11, further comprising:
distributing the positions of the audio sources associated with the first sound field or the second sound field at different distances from the point in the region in the first transformed sound field or the second transformed sound field.

14. The method of claim 1, wherein the receiving the image of the object comprises:
determining a quantity of audio streams including the first audio stream and the second audio stream;

15. The method of claim 1, further comprising:
determining a position of the audio space; and
steering a subset of the transducers to project the sound beams to the position of the audio space;

16. The method of claim 1, wherein receiving the first audio stream and the second audio stream respectively comprise:
receiving data representing three-dimensional audio originating in the first sound field relative to a first binaural audio-receiving device coextensive with the first reference point; and
receiving data representing three-dimensional audio originating in the second sound field relative to a binaural audio receiving device coextensive with the second reference point.

17. A system comprising:
a media device comprising:
a housing;
a transceiver disposed in the housing and configured to communicate multiple radio frequency (“RF”) communication signals with multiple devices, the multiple RF communication signals including packets;
a plurality of transducers disposed in the housing and configured to emit acoustic signal into a region external to the housing;
a memory including executable instructions; and
a processor configured to:
execute a first portion of the executable instructions to receive audio streams;
execute a second portion of the executable instructions to transform one or more spatial dimensions to form transformed sound fields;
execute a third portion of the executable instructions to selecting a subset of one or more parameters;
execute a fourth portion of the executable instructions to form a transformed reproduced sound field in which the transformed sound fields are disposed in portions of the transformed reproduced sound field based on the subset of the one or more parameters; and
execute a fifth portion of the executable instructions to cause transducers to project sound beams at a point in a region to form an audio space at which spatial audio is produced to include the transformed reproduce sound fields.

18. The system of claim 17, wherein the processor is further configured to:
execute a sixth portion of the executable instructions to select a subset of one or more parameters to determine a size for a transformed reproduced sound field, and to adjust the size of the transformed reproduced sound field, or
execute a seventh portion of the executable instructions to select a subset of the one or more parameters to determine the transformed sound field to dispose into a portion of the transformed reproduced sound field.

19. The system of claim 17, further comprising:
an audio source distributor configured to distribute positions of audio sources associated with at least one of the transformed sound fields at different distances from the point in the region or equidistant relative to each other.

20. The system of claim 17, further comprising:
a spatial audio generator configured to produce the spatial audio in which a plurality of transformed sound fields in the transformed reproduced sound field include binaural audio that is spatially adjusted for receive at the audio space.
